(19) United States
(12) Patent Application Publication
(10) Pub. No.: US 2007/0231623 A1
(43) Pub. Date: Oct. 4, 2007

(54) METHOD OF OPERATION OF A FUEL CELL SYSTEM AND OF CEASING THE SAME

(76) Inventors: Uwe M. Limbeck, Kirchheim/Teck (DE); Holger Richter, Kirchheim/Teck (DE)

Correspondence Address: SEED INTELLECTUAL PROPERTY LAW GROUP PLLC, 701 FIFTH AVE, SUITE 5400, SEATTLE, WA, 98104, US

(21) Appl. No.: 11/278,317

(22) Filed: Mar. 31, 2006

(51) Int. Cl. H01M 8/00

(52) U.S. Cl. 429/13; 429/23

(57) ABSTRACT

A method of ceasing operation of a fuel cell system comprises terminating a supply of a hydrogen-containing fuel to a fuel cell stack, drawing a potential of the fuel cell stack to a load to substantially consume hydrogen in the fuel cell stack, introducing a dose of air to at least a portion of anode electrode layers from at least one of an air supply source and an external source, and reacting hydrogen and oxygen in the anode electrode layers to consume substantially all the hydrogen remaining in the fuel cell stack.

### BACKGROUND OF THE INVENTION

1. Field of the Invention

The present invention generally relates to electrochemical energy converters, such as fuel cells or stacks of such cells, and more particularly, to methods for ceasing operation of the same.

2. Description of the Related Art

Electrochemical fuel cells comprising ion exchange membranes, such as proton exchange membranes (PEMs) may be operated as fuel cells, wherein a fuel and an oxidant are electrochemically converted at the fuel cell electrodes to produce electrical power. FIGS. 1-3 collectively illustrate a typical design of a conventional membrane electrode assembly 5, an electrochemical fuel cell 10 comprising a PEM 2, and a stack 50 of such fuel cells.

Each fuel cell 10 comprises a membrane electrode assembly (“MEA”) 5 such as that illustrated in an exploded view in FIG. 1. The MEA 5 comprises a PEM 2 interposed between anode and cathode electrode layers 1, 3 which are typically porous and electrically conductive, and each of which comprises an electrocatalyst at its interface with the PEM 2 for promoting the desired electrochemical reaction. The electrocatalyst is typically a precious metal composition (e.g. platinum metal black or an alloy thereof) and may be provided on a suitable support (e.g. carbon black support). The electrocatalyst generally defines the electrochemically active area of the fuel cell. The MEA 5 is typically consolidated as a bonded, laminated assembly.

In an individual fuel cell 10, illustrated in an exploded view in FIG. 2, an MEA 5 is interposed between first and second separator plates 11, 12, which are typically fluid impermeable and electrically conductive. The separator plates 11, 12 are manufactured from non-metals, such as graphite; from metals, such as certain grades of steel or surface treated metals; or from electrically conductive plastic composite materials.

Fluid flow spaces, such as passages or chambers, are provided between the separator plates 11, 12 and the adjacent electrode layers 1, 3 to facilitate access of reactants to the electrode layers and removal of products. More commonly, channels or flow fields are formed on the surface of the separator plates 11, 12 that face the electrode layers 1, 3. Separator plates 11, 12 comprising such channels are commonly referred to as fluid flow field plates. In conventional fuel cells 10, resilient gaskets or seals are typically provided around the perimeter of the flow fields between the faces of the MEA 5 and each of the separator plates 11, 12 to prevent leakage of fluid reactant and product streams.

Electrochemical fuel cells 10 with ion exchange membranes such as PEM 2, sometimes called PEM fuel cells, are advantageously stacked to form a stack 50 (see FIG. 3) comprising a plurality of fuel cells disposed between first and second end plates 17, 18. A compression mechanism is typically employed to hold the fuel cells 10 tightly together, to maintain good electrical contact between components, and to compress the seals. As illustrated in FIG. 2, each fuel cell 10 comprises a pair of separator plates 11, 12 in a configuration with two separator plates per MEA 5. Cooling spaces or layers may be provided between some or all of the adjacent pairs of separator plates 11, 12 in the stack 50. The illustrated fuel cell elements have openings 30 formed therein which, in the stacked assembly, align to form fluid manifolds for supply and exhaust of reactants and products, respectively, and, if cooling spaces are provided, for a cooling medium. Again, resilient gaskets or seals are typically provided between the faces of the MEA 5 and each of the separator plates 11, 12 around the perimeter of these fluid manifold openings 30 to prevent leakage and intermixing of fluid streams in the operating stack 50.

It is well known that when ceasing operation of a fuel cell stack with uncontrolled methods, hydrogen and oxygen may diffuse across the PEM causing an inhomogeneous distribution of oxygen and hydrogen on the anode electrode layer and undesirable anode and cathode half-cell potentials may result in at least a portion of the fuel cells in the fuel cell stack. These conditions may lead to oxidation and degradation of at least some of the fuel cell components, and result in lifetime and performance losses of the fuel cell stack. Additionally, since components of the fuel cell stack may include materials such as carbon, oxidation in the fuel cell stack may result in emission of environmentally harmful fluids such as carbon dioxide (CO₂).

Methods have been introduced to minimize or attempt to substantially alleviate undesirable anode and cathode potentials, including drawing current to consume remaining hydrogen in the system upon shutdown and using high purge fluxes to blow the hydrogen out of the system. However, such methods have not achieved consuming substantially all of the hydrogen in the system upon shutdown.

Other methods have focused on disconnecting the primary load and continuing electrochemical reactions, which may result in fuel waste. Additionally, efficacy of such methods typically depends on an appropriate balance of oxygen and hydrogen remaining in the system to substantially consume the hydrogen; however, undesirable shutdown conditions include inhomogeneous distribution of oxygen and hydrogen, hence, these methods may result in inadequate hydrogen consumption upon shutdown. Yet other solutions have attempted to incorporate compressors and auxiliary loads to assist hydrogen consumption; however, these methods may be time-consuming and tend to introduce additional cost and space requirements associated with such devices.

Accordingly, it is desirable to develop methods for ceasing operation of a fuel cell stack so that undesirable anode and cathode half-cell potentials are substantially alleviated in an expedited, cost-effective and space-conserving manner.

### BRIEF SUMMARY OF THE INVENTION

According to one embodiment, a method of ceasing operation of a fuel cell system having a plurality of fuel cells forming a fuel cell stack, each fuel cell comprising a membrane electrode assembly having an ion exchange membrane interposed between anode and cathode electrode layers, a first flow field plate positioned adjacent the anode electrode layer of each membrane electrode assembly and adapted to direct a hydrogen-containing fuel from a fuel supply source to at least a portion of the anode electrode layer of each membrane electrode assembly, a second flow field plate positioned adjacent the cathode electrode layer of each membrane electrode assembly and adapted to direct air from an air supply source to at least a portion of the cathode electrode layer of each membrane electrode assembly, comprises the steps of: terminating the supply of the hydrogen-containing fuel to the fuel cell stack, drawing a potential of the fuel cell stack to a load to substantially consume hydrogen in the fuel cell stack, introducing a dose of air to at least a portion of the anode electrode layers from at least one of the air supply source and an external source, and reacting hydrogen and oxygen in the anode electrode layers to consume substantially all the hydrogen remaining in the fuel cell stack.

### BRIEF DESCRIPTION OF THE SEVERAL VIEWS OF THE DRAWING(S)

FIG. 1 is an exploded isometric view of a membrane electrode assembly according to the prior art.

FIG. 2 is an exploded isometric view of an electrochemical fuel cell according to the prior art.

FIG. 3 is an isometric view of an electrochemical fuel cell stack according to the prior art.

FIG. 4 is a block diagram of a fuel cell system according to one embodiment of the present invention.

FIG. 5 is a block diagram of a fuel cell system according to another embodiment of the present invention.

FIG. 6 is a block diagram of a fuel cell system according to yet another embodiment of the present invention.

FIG. 7 is a block diagram of a fuel cell system according to still another embodiment of the present invention.

FIG. 8 is a chart comparing CO₂ emissions associated with an embodiment of the present invention with CO₂ emissions associated with existing methods.

FIG. 9 is a chart comparing an integrated amount of CO₂ emissions associated with an embodiment of the present invention with an integrated amount of CO₂ emissions associated with existing methods.

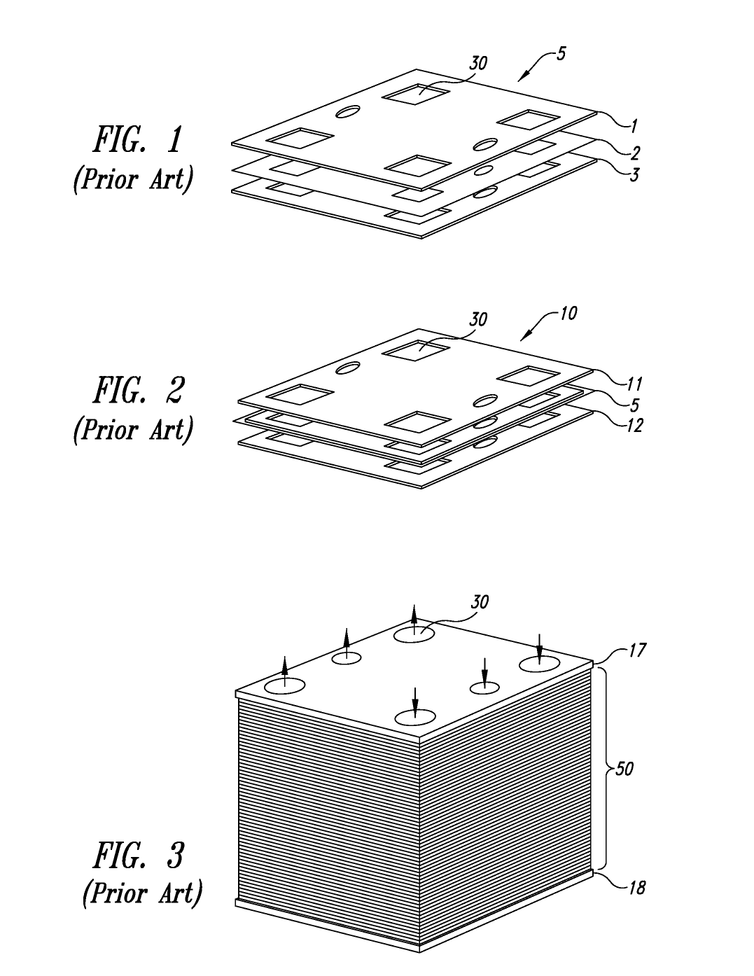

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

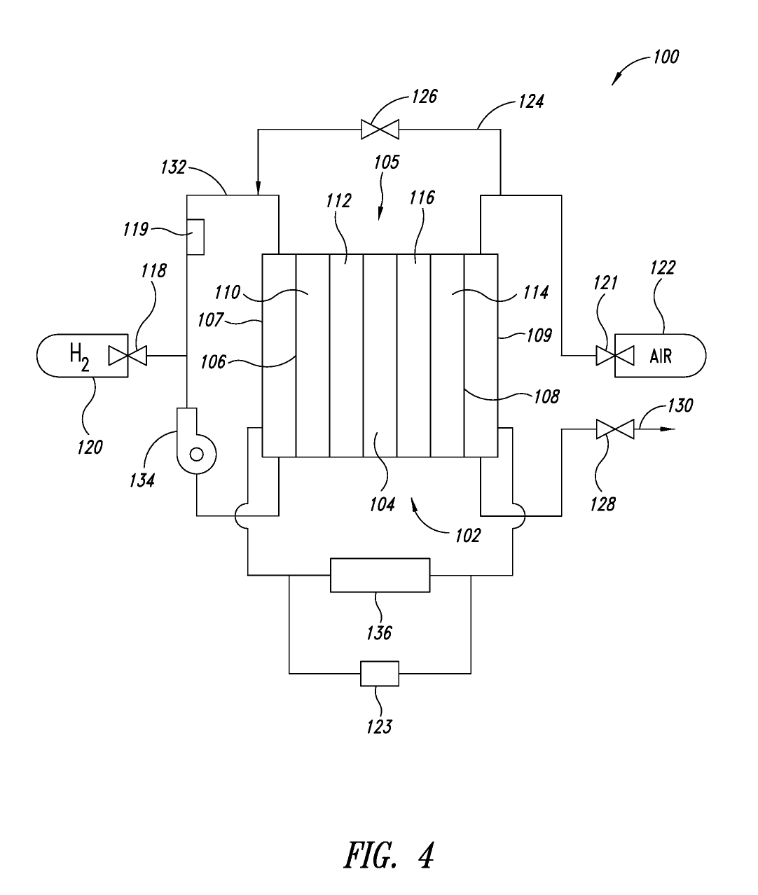

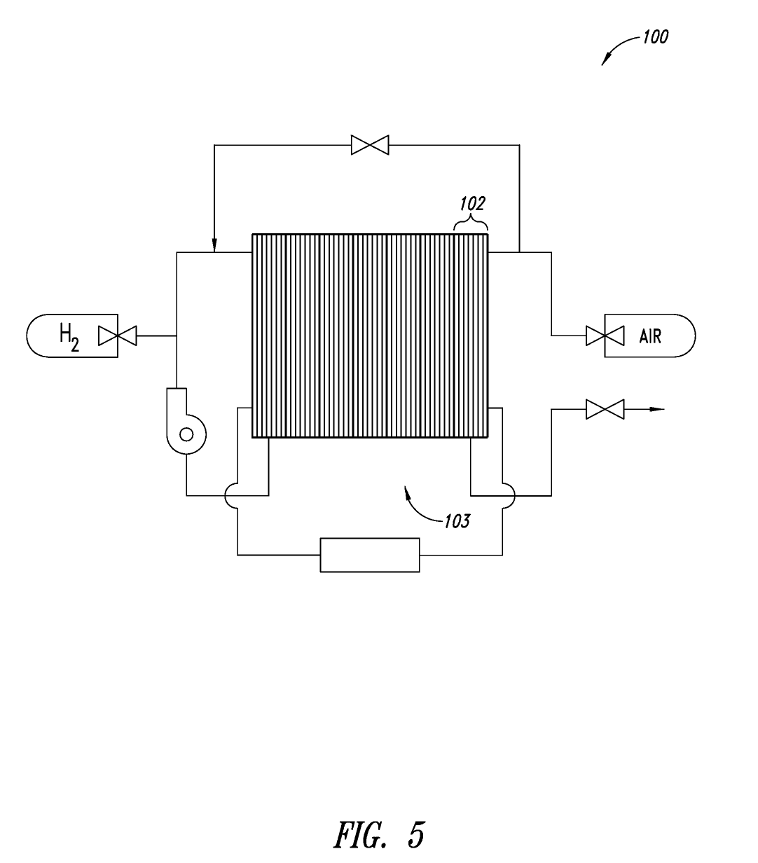

FIG. 4 illustrates one embodiment, in which a fuel cell system 100 comprises at least one fuel cell 102 having a membrane electrode assembly (MEA) 105. For clarity of illustration and description, one fuel cell 102 is shown in FIG. 4; however, the fuel cell system 100 may comprise a plurality of fuel cells 102 forming a fuel cell stack 103 as shown in FIG. 5.

Referring to FIG. 4, the MEA 105 of the fuel cell 102 comprises an ion-exchange membrane 104, such as a proton exchange membrane, interposed between an anode electrode layer 106 and a cathode electrode layer 108. The anode electrode layer 106 includes a substrate 110 and an anode electrocatalyst layer 112. Similarly, the cathode electrode layer 108 includes a substrate 114 and a cathode electrocatalyst layer 116.

The fuel cell system 100 may comprise a first flow control device 118 to control a supply of a hydrogen-containing fuel from a fuel supply source 120 to at least a portion of the anode electrode layer 106. The fuel cell system 100 may also comprise a second flow control device 121 to control a supply of an oxidant, such as oxygen or air, from an air supply source 122 to at least a portion of the cathode electrode layer 108.

The fuel cell 102 further comprises a first flow field plate 107 positioned adjacent the anode electrode layer 106 and adapted to direct the hydrogen-containing fuel from the fuel supply source 120 to at least a portion of the anode electrode layer 106. Similarly, the fuel cell 102 comprises a second flow field plate 109 positioned adjacent the cathode electrode layer 108 and adapted to direct air from the air supply source 122 to at least a portion of the cathode electrode layer 108.

Upon introduction of the fuel to the fuel cell 102 from the fuel supply source 120, the anode electrocatalyst layer 112 splits the hydrogen molecules into protons and electrons, the protons passing through the ion-exchange membrane 104 in a first direction while the electrons are blocked by the ion-exchange membrane 104 from traveling in the first direction, and are routed to an external circuit, producing electrical power. The protons travel through the membrane 104 and through the cathode electrode layer 108 to combine with the electrons returning from the external circuit and the oxygen fed to the cathode electrode layers 108 from the air supply source 122 to generate water, water vapor, heat and/or other by-products, which are purged from the fuel cell system 100 as exhaust gas or liquid or both.

The fuel cell system 100 may further comprise an air dosing line 124 and a third flow control device 126, such as a purge valve or an air bleed valve. The fuel cell system 100 may further comprise a fourth flow control device 128, such as a purge valve downstream of the fuel cell 102 for purging the byproducts to a vent 130 or other location. Alternatively, the byproducts may directly exhaust through the vent 130.

The fuel cell system 100 may further comprise a recirculation line 132 in fluid communication with at least the anode electrode layer 106. The recirculation line my include a pump device 134, such as a blower or a jet pump, expediting recirculation of anode gases such as hydrogen, nitrogen and/or air, and promoting homogeneous hydrogen distribution along the anode electrode layer 106.

According to one embodiment, a method of ceasing operation of the fuel cell system 100 comprises terminating the supply of the hydrogen-containing fuel to the fuel cell 102. Moreover, the method comprises drawing a potential from the fuel cell 102 to substantially consume hydrogen in the fuel cell 102 and to reduce a potential of the fuel cell 102. The hydrogen is consumed and the potential reduced through electrochemical reactions in the absence of additional hydrogen being supplied to the fuel cell 102, particularly to the anode electrode layer 106.

The potential may be drawn by any suitable load that can be internal or external with respect to the fuel cell 102, such as, but not limited to, a battery, a blower, the pump device 134, a primary load 136 such as a propulsion motor of a vehicle without moving the vehicle, a resistive heater and/or any other suitable load operable to draw potential from the fuel cell 102. It is not necessary to incorporate an auxiliary load for this step or to disconnect the primary load and connect the auxiliary load. Therefore, embodiments of the present invention are less expensive, less time-consuming and more expedient than existing methods, using auxiliary loads as part of the shutdown procedure of fuel cell systems. However, if desired, an optional auxiliary load may be included in some embodiments.

The method further comprises introducing a dose of air to at least a portion of the anode electrode layer 106 from the air supply source 122 and/or an external source, such as an ambient air supply source or an external air supply reservoir. In the illustrated embodiment of FIG. 4, air is dosed to the anode electrode layer 106 via the air dosing line 124, which is in fluid communication with the air supply source 122. The third flow control device 126 can be used to control the dosage of air being supplied to the anode electrode layer 106 during ceasing operation of the fuel cell system 100. Introduction of the dose of air promotes reacting hydrogen and oxygen in the anode electrode layer 106 to consume substantially all the hydrogen remaining in the fuel cell 102.

A magnitude of a pressure of the anode electrode layer 106 may reduce below a magnitude of an ambient pressure through consumption of hydrogen as described above, enabling the anode electrode layer 106 to passively draw air from the air dosing line 124, or any other suitable air supply source such as the ambient or the external air supply reservoir. Therefore, dosing air to the anode electrode layer 106 may occur without employing an air compressor or similar device to dose air to at least a portion of the anode electrode layer 106. Accordingly, this embodiment of the present invention further saves space and cost associated with devices such as a compressor. Alternatively, if desired, other embodiments of the present invention may further comprise devices to promote dosing air to at least a portion of the anode electrode layer 106, such as a compressor.

Furthermore, anode gases may be recirculated in the recirculation line 132, using the pump device 134 to promote homogeneous distribution of hydrogen about the anode electrode layer 106 and/or pump any remaining hydrogen from the recirculation line 132 into the fuel cell 102 for consumption. The electrochemical reaction between hydrogen and oxygen in the fuel cell 102 can occur over the anode electrocatalyst layer 112 to expedite hydrogen consumption and shutdown of the fuel cell system 100.

Typically, as the hydrogen concentration reduces, the potential of the fuel cell 102 also lessens. To avoid cell reversals (i.e., cell potential levels below 0 Volts), the load can be disconnected upon achieving a predetermined reduced potential of the fuel cell 102. In some embodiments, the predetermined reduced potential can be approximately between 0.15 Volts and 0.4 Volts for each fuel cell. In some embodiments the predetermined reduced potential level can be approximately 0.25 Volts for each fuel cell.

The method further comprises terminating the supply of air to the cathode electrode layer 108 from the air supply source 122 upon achieving the predetermined reduced potential of the fuel cell 102. Additionally, the method comprises, disconnecting the primary load 136 from the fuel cell system 100. The primary load 136 can be disconnected at any time after the method commences; however, if the primary load 136 is drawing potential from the fuel cell 102 during the hydrogen consumption, then disconnecting the primary load 136 may occur after reaching the predetermined reduced potential of the fuel cell 102.

The fuel cell system 100 may comprise at least a first optional sensor 119 in electrical communication with the second flow control device 121, operable to measure a concentration of hydrogen. Upon sensing a predetermined hydrogen concentration that may or may not be associated with the predetermined reduced potential, the first sensor 119 can communicate with the second flow control device 121 to control and/or terminate the supply of air to the fuel cell 102 from the air supply source 122. The first sensor 119 can be positioned in any suitable location having exposure to a hydrogen concentration substantially representative of the hydrogen concentration remaining in the fuel cell system 100, such as the recirculation line 132.

Additionally, or alternatively, the fuel cell system 100 may comprise a second sensor 123 operable to measure a potential of the fuel cell 102. Upon sensing the predetermined reduced potential, the second sensor 123 can communicate with the load, such as the primary load 136 and/or the pump device 134 to control and/or terminate drawing potential from the fuel cell 102, for example by disconnecting the load. The second sensor 123 may also be in electrical communication with the second flow control device 121 to control and/or terminate the supply of air to the fuel cell 102 from the air supply source 122, upon sensing the predetermined reduced potential of the fuel cell 102.

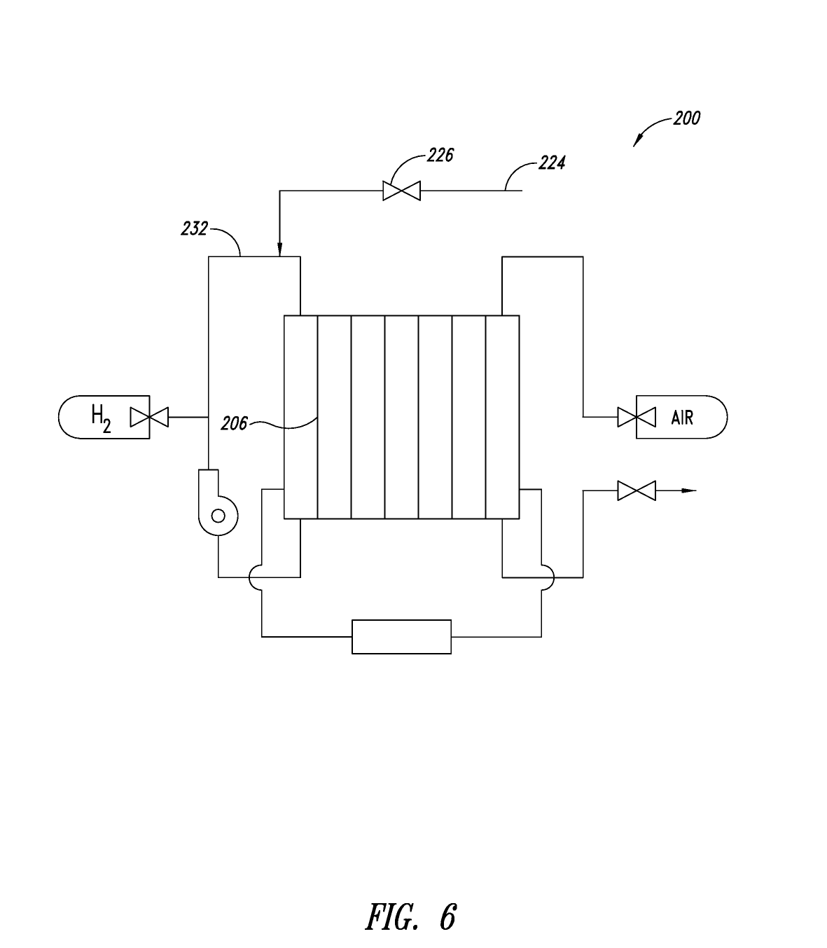

FIG. 6 illustrates another embodiment, in which air is dosed to a recirculation line 232 and/or an anode electrode layer 206 from a port 224, which is exposed to the ambient. A method of ceasing operation of a fuel cell system 200 shown in FIG. 6 is similar to that described above in conjunction with FIG. 4, except that in this embodiment, introducing a dose of air to at least a portion of the anode electrode layer 206 comprises passively and/or selectively introducing the dose of air to at least a portion of the anode electrode layer 206 from an external source such as the ambient. The supply of air can be controlled with a flow control device 226.

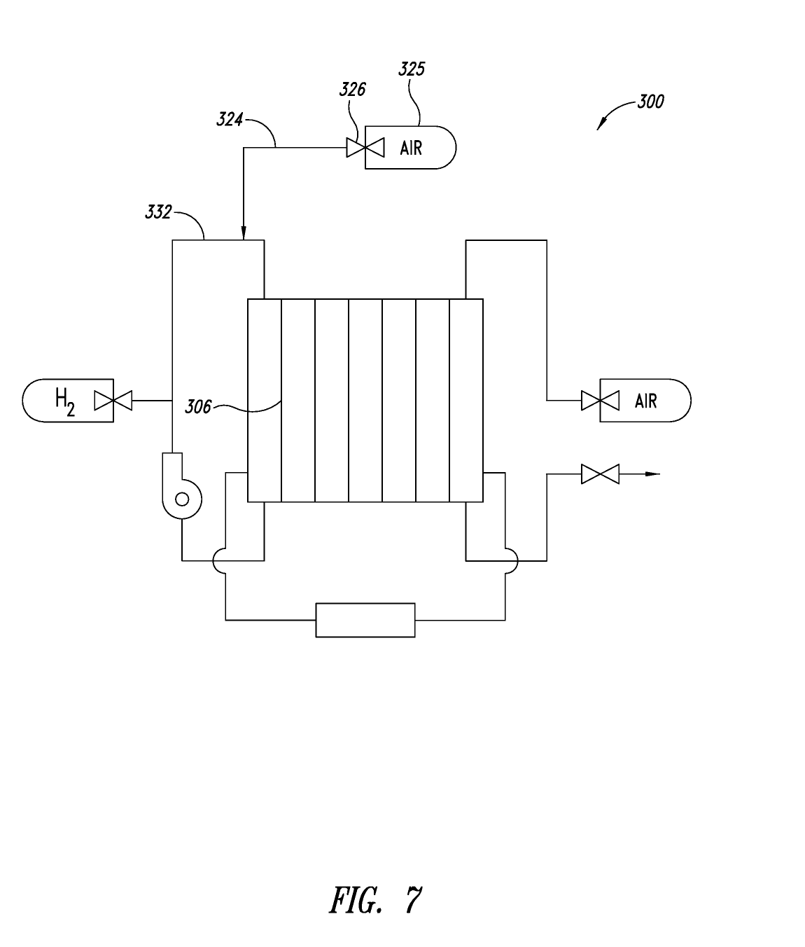

FIG. 7 illustrates yet another embodiment, in which air is dosed to a recirculation line 332 and/or an anode electrode layer 306 from a dosing line 324 terminating in an at least partially bounded external air supply source 325, such as a reservoir. A method of ceasing operation of a fuel cell system 300 shown in FIG. 7 is similar to embodiments described above, except that in this embodiment, introducing a dose of air to at least a portion of the anode electrode layer 306 comprises passively and/or selectively introducing the dose of air to at least a portion of the anode electrode layer 306 from an at least partially bounded external air supply source 325, such as a reservoir. The supply of air can be controlled with a flow control device 326.

It is understood that although certain details are provided for a thorough understanding of the embodiments described, other embodiments may exclude some of the described features or incorporate additional features. For example, the flow control devices 126, 226, 326 can be omitted and the fuel cell system designed to commence dosing air to at least a portion of the anode electrode layers 106, 206, 306 during ceasing operation of the fuel cell system, upon reduction of the pressure of the anode electrode layer below ambient pressure, in response to hydrogen consumption. Additionally, or alternatively, a pump device, such as a blower, may be incorporated in the air dosing lines 124, 224, 324 to promote homogeneous distribution of air to at least a portion of the anode electrode layers 106, 206, 306 during ceasing operation of the fuel cell system 100. An individual of ordinary skill in the art, having reviewed this disclosure, will appreciate these and other modifications that can be made to the embodiments described, without deviating from the spirit of the invention.

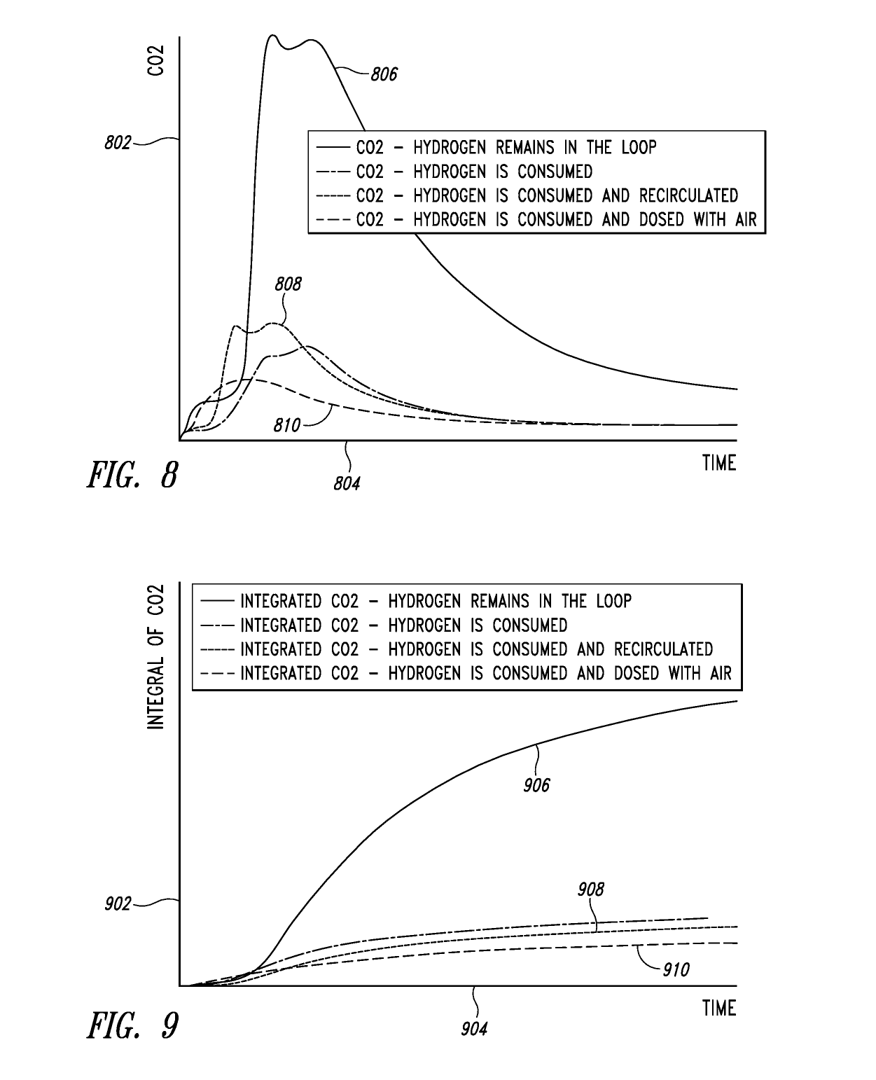

A comparison of different shutdown methods with respect to carbon dioxide emissions is illustrated in FIGS. 8 and 9. FIG. 8 illustrates CO₂ emissions that are measured at an outlet, such as a cathode outlet, on a first axis 802, with respect to time, represented by a second axis 804. FIG. 9 illustrates an integrated amount of the CO₂ emissions on a first axis 902, with respect to time, represented by a second axis 904. The amount of CO₂ emissions can represent a measure of adverse environmental effects and, since CO₂ can be corrosive, of degradation of a fuel cell system. As apparent from the results shown in FIGS. 8 and 9, the existing and known method of uncontrolled shutdown of existing fuel cell systems exhibited the highest CO₂ emissions depicted by solid curves 806, 906, with some benefits gained by using a recirculation blower while the hydrogen is consumed, depicted by short dashed curves 808, 908.

FIGS. 8 and 9 also illustrate that a method of ceasing operation of a fuel cell system according to an embodiment of the present invention, depicted by long dashed curves 810, 910, revealed the least amount of CO₂ emissions.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and their equivalents.

1. A method of ceasing operation of a fuel cell system having a plurality of fuel cells forming a fuel cell stack, each fuel cell comprising a membrane electrode assembly having an ion exchange membrane interposed between anode and cathode electrode layers, a first flow field plate positioned adjacent the anode electrode layer of each membrane electrode assembly and adapted to direct a hydrogen-containing fuel from a fuel supply source to at least a portion of the anode electrode layer of each membrane electrode assembly, a second flow field plate positioned adjacent the cathode electrode layer of each membrane electrode assembly and adapted to direct air from an air supply source to at least a portion of the cathode electrode layer of each membrane electrode assembly, the method comprising:
terminating the supply of the hydrogen-containing fuel to the fuel cell stack;
drawing a potential of the fuel cell stack to a load to substantially consume hydrogen in the fuel cell stack;
introducing a dose of air to at least a portion of the anode electrode layers from at least one of the air supply source and an external source; and
reacting hydrogen and oxygen in the anode electrode layers to consume substantially all the hydrogen remaining in the fuel cell stack.

2. The method of claim 1, further comprising terminating the supply of air to the cathode electrode layers upon achieving a predetermined reduced potential of the fuel cell stack.

3. The method of claim 2, wherein the predetermined reduced potential is approximately between 0.15 Volts and 0.4 Volts for each fuel cell.

4. The method of claim 2, further comprising disconnecting the load upon achieving the predetermined reduced potential of the fuel cell stack.

5. The method of claim 4, wherein the predetermined reduced potential is approximately 0.25 Volts for each fuel cell.

6. The method of claim 4, wherein:
the fuel cell system further comprises at least one sensor operable to measure the potential of the fuel cell stack and electrically communicate with the load; and
disconnecting the load is in response to the sensor detecting the predetermined reduced potential.

7. The method of claim 6, wherein:
the fuel cell system further comprises a flow control device operable to control the supply of air to the fuel cell stack;
the sensor is operable to electrically communicate with the flow control device; and
terminating the supply of air to the cathode electrode layers is in response to the sensor detecting the predetermined reduced potential.

8. The method of claim 1, wherein the fuel cell system further comprises a recirculation line in fluid communication with at least a portion of the anode electrode layers and the method further comprises recirculating at least one of hydrogen, nitrogen and air in the recirculation line.

9. The method of claim 8, wherein the recirculation line comprises a pump device and the method further comprises pumping hydrogen from the recirculation line to at least a portion of the anode electrode layers to substantially consume the hydrogen remaining in the fuel cell stack.

10. The method of claim 8, wherein the fuel cell system further comprises a flow control device operable to control the supply of air to the fuel cell stack and at least one sensor operable to measure a concentration of hydrogen and electrically communicate with the flow control device to control the supply of air to the fuel cell stack, and the method further comprises terminating the supply of air to the fuel cell stack in response to the sensor detecting a predetermined hydrogen concentration.

11. The method of claim 10, further comprising positioning the sensor proximate the recirculation line.

12. The method of claim 1, wherein the flow of air is passively introduced to the anode electrode layers from at least one of the air supply source and the external source by drawing the potential of the fuel cell stack to consume the hydrogen and reducing a magnitude of a pressure of the anode electrode layers to below a magnitude of an ambient pressure.

13. The method of claim 1, wherein the anode electrode layers each comprise an anode electrocatalyst layer and reacting the hydrogen and the oxygen in the anode electrode layers to substantially consume the hydrogen in the fuel cell stack occurs on at least a portion of the anode electrocatalyst layer.

14. The method of claim 1, wherein drawing a potential of the fuel cell stack occurs independent of an auxiliary load.

15. The method of claim 1, further comprising disconnecting the primary load from the fuel cell stack.
